(19) United States
(12) Patent Application Publication
(10) Pub. No.: US 2016/0112677 A1
(43) Pub. Date: Apr. 21, 2016

(54) METHOD FOR MANAGING A SURVEILLANCE SYSTEM, AND ASSOCIATED APPARATUS

(71) Applicant: Synology Incorporated, Taipei (TW)

(72) Inventors: Szu-Hsien Lee, Taipei City (TW); Bo-Shao Lin, Taipei City (TW); Ying-Kai Wang, Taipei City (TW)

(21) Appl. No.: 14/873,218

(22) Filed: Oct. 2, 2015

(30) Foreign Application Priority Data
Oct. 17, 2014 (TW) 103136016

(51) Int. Cl. H04N 7/18; H04N 5/232

(52) U.S. Cl. CPC H04N 7/181; H04N 5/23216

(57) ABSTRACT

A method for managing a surveillance system and an associated apparatus, where the surveillance system includes at least one camera, such as a Pan-Tilt-Zoom (PTZ) camera or other types of cameras, and the method is applied to a control circuit of the surveillance includes the steps of: according to statistics data, predicting at least one time interval that complies with a predetermined condition to determine target time, and performing a timing operation corresponding to the target time, where the predetermined condition relates to an event count occurrence probability of the time interval, and the target time falls within the time interval; and when the target time expires, performing at least one configuration updating operation upon the camera.

### BACKGROUND OF THE INVENTION

1. Field of the Invention

The present invention relates to setting a camera, such as a pan-tile-zoom (PTZ) camera (or other types of camera) and updating the configuration thereof. More particularly, the present invention relates to a method for managing a surveillance system, and an associated apparatus.

2. Description of the Prior Art

Based on related techniques, when a user modifies settings of one or multiple PTZ cameras in a conventional digital surveillance system, the conventional digital surveillance system will perform a conventional update flow by pausing the video recording to apply new settings on the PTZ cameras. The length of the pause period varies with the workload of the conventional digital surveillance system, the network situation, the properties of the PTZ cameras, and the usage situations of the PTZ cameras. Hence, some side effects may be introduced. For example, the pause period caused by the conventional update flow may be very long. In this situation, when outside events occur, the conventional digital surveillance system may not be able to record and thus fails to preserve video evidence related to these events. In another example, even if the pause period caused by the conventional update flow is not very long, the conventional digital surveillance system still cannot preserve evidence of any event which occurs during the pause period due to the conventional update flow. Therefore, there is a need for a novel method to improve the performance of conventional digital surveillance systems.

### SUMMARY OF THE INVENTION

One objective of the present invention is to provide a method for managing a surveillance system, and an associated apparatus, to solve the issues mentioned above.

Another objective of the present invention is to provide a method for managing a surveillance system, and an associated apparatus, which can ensure that no important video data is lost and evidence related to any events can be preserved.

Yet another objective of the present invention is to provide a method for managing a surveillance system, and an associated apparatus, which can adaptively search a best time point for setting a camera such as a pan-tilt-zoom (PTZ) camera, and more particularly, a best time point for updating configurations of the camera.

According to at least one preferred embodiment of the present invention, a method for managing a surveillance system is provided. The surveillance system includes at least one camera. The method is applied to a control circuit of the surveillance system, and comprises: predicting at least one time interval that complies with a predetermined condition based on statistics data to determine a target time and perform a timing operation corresponding to the target time, wherein the predetermined condition relates to an event count of the at least onetime interval, and the target time is within the at least one time interval; and performing at least one configuration updating operation upon the at least one camera when the target time expires.

In addition to the method mentioned above, the present invention also provides an apparatus for managing a surveillance system. The surveillance system includes at least one camera. The apparatus includes at least a portion of the surveillance system, and includes an interface circuit and a control circuit. The interface circuit is arranged to couple to the at least one camera. The control circuit is coupled to the interface circuit. The control circuit is arranged to predict at least one time interval that complies with a predetermined condition based on statistics data to determine a target time, and perform a timing operation corresponding to the target time, wherein the predetermined condition relates to an event count of the at least one time interval, the target time is within the at least one time interval, and the control circuit performs at least one set of configuration updating operations upon the at least one camera when the target time expires.

An advantage of the present invention is that, compared with the related art, the method and the apparatus of the present invention may improve the reliability of the surveillance system. Further, the method and the apparatus of the present invention may ensure no important video data is lost, so that evidence related to events can be preserved. The method and the apparatus of the present invention may determine the urgency of immediately applying a new configuration. For example, the method and the apparatus of the present invention may determine the best timing for applying a new configuration according to whether the new configuration is urgent, the history statistics data of the camera and the preference sets of the user. More particularly, the method and the apparatus of the present invention may adaptively find the best timing for updating configurations of the camera, thus improving the flexibility.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus arranged for managing a surveillance system according to an embodiment of the present invention.

FIG. 2 is a flowchart illustrating a method arranged for managing a surveillance system according to an embodiment of the present invention.

FIG. 3 is a diagram illustrating a control scheme involved by the method shown in FIG. 2 according to an embodiment of the present invention.

FIG. 4 is a diagram illustrating a work flow involved by the method shown in FIG. 2 according to an embodiment of the present invention.

FIG. 5 is a diagram illustrating an apparatus arranged for managing a surveillance system according to another embodiment of the present invention.

### DETAILED DESCRIPTION

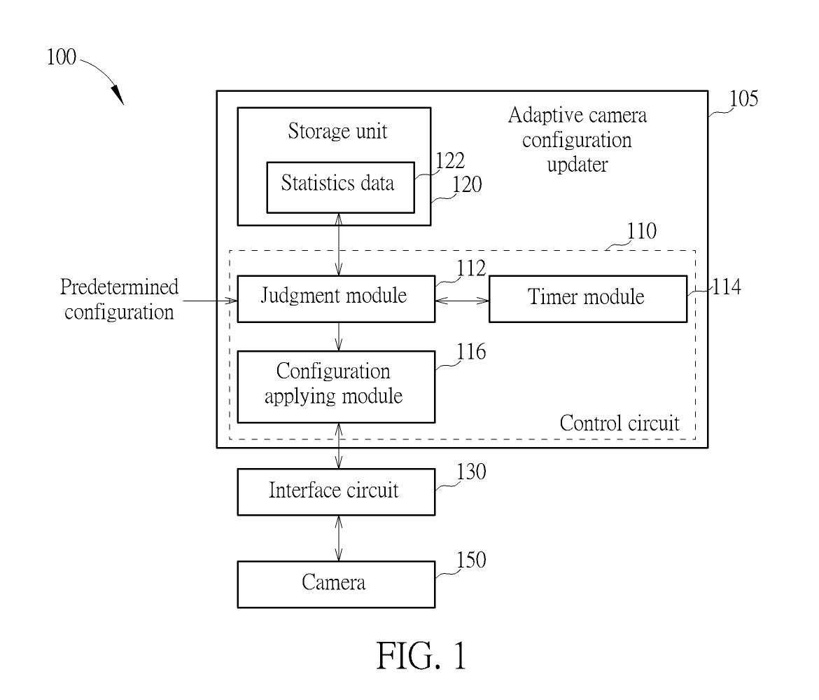

FIG. 1 is a diagram illustrating an apparatus arranged for managing a surveillance system 100 according to an embodiment of the present invention, wherein the surveillance system includes at least one camera 1, and the apparatus 100 may include at least a portion (e.g. part or all) of the surveillance system. The aforementioned at least one camera can be at least one camera capable of adjusting filming directions, such as one or multiple pan-tilt-zoom (PTZ) cameras. The camera can also be other types of camera, such as zoom cameras. In this embodiment, the camera 150 shown in FIG. 1 may represent the aforementioned at least one camera, such as the aforementioned one or multiple PTZ cameras or other types of cameras.

Each of the aforementioned one or multiple PTZ cameras may store some specific configurations, and automatically perform any operation of panning, tilting and zooming based on the specific configurations, or based on various combinations of these operations. The specific configurations may be updated to make the operation of adjusting the filming directions and/or zooming change accordingly. For example, when the apparatus 100 applies at least one predetermined configuration (e.g. one or multiple predetermined configurations) on the camera such as the aforementioned one or multiple PTZ cameras, the camera may automatically perform any operation of panning, tilting and zooming, or various combinations of these operations based on the predetermined configuration.

As shown in FIG. 1, the apparatus 100 includes an intelligent and adaptive camera configuration updater 105 and an interface circuit 130. More particularly, the intelligent and adaptive camera configuration updater 105 of the present invention may be implemented through utilizing a control circuit 110 and a storage unit 120. The control circuit 110 may include one or multiple program modules, such as a judgment module 112, a timer module 114 and a configuration applying module 116, wherein the judgment module 112 may perform various decision and control operations, the timer module 114 may perform timing operations for the judgment module 112, and the configuration applying module 116 may perform configuration applying operation upon the camera 150 based on the control of the judgment module 112. The aforementioned one or multiple program modules can be firmware modules. This is merely for illustrative purposes, however, and not a limitation of the present invention. The aforementioned one or multiple program modules may be software modules. In another example, the aforementioned one or multiple program modules may be implemented as modules inside a customized integrated circuit (IC).

In practice, the control circuit 110 may be implemented through utilizing a micro control unit (MCU) or a microcontroller. Further, the storage unit 120 in this embodiment may be used to store the statistics data 122, and may be configured to be outside the control circuit 110, wherein the control circuit 110 is coupled to the interface circuit 130, and the storage unit 120 is coupled to the control circuit 110. According to some embodiments, however, the storage unit 120 may be integrated inside the control circuit 110.

According to this embodiment, the interface circuit 130 may be utilized to couple to the camera, i.e. the camera 150 shown in FIG. 1. Further, the control circuit 110 may generate statistics data 122, and may also update the statistics data 122, wherein the statistics data 122 may include statistics data related to events, and more particularly, to the historical data of some events happened during some time intervals. The control circuit 110 may predict the best time point for performing configuration updating based on the statistics data 122, and perform a timing operation accordingly, so as to selectively perform at least one set of configuration updating operations (e.g. applying a new configuration to the aforementioned at least one camera) at the aforementioned best time point, wherein when the best time point is up, the control circuit 110 may determine whether the current time point is suitable for performing the set of configuration updating operations in advance, and then determine whether to immediately perform the set of configuration updating operations. If the control circuit 110 determines that the current time point is suitable for performing the set of configuration updating operations, they will be immediately performed by the control circuit 110; otherwise, the control circuit 110 may predict a best time point again for performing configuration updating based on the latest contents of the statistics data 122, so as to selectively perform the set of configuration updating operations at the new predicted best time point.

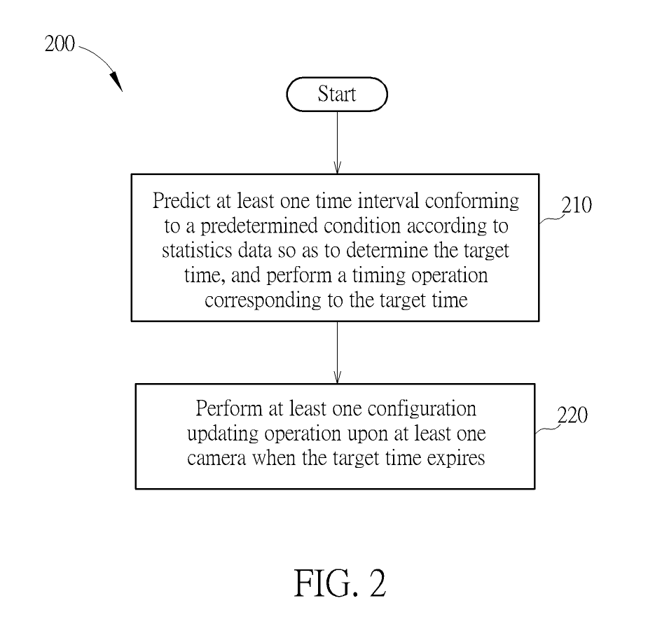

FIG. 2 is a flowchart illustrating a method 200 arranged for managing a surveillance system according to an embodiment of the present invention. The method 200 may be applied to the apparatus 100 shown in FIG. 1, and more particularly, to the intelligent and adaptive camera configuration updater 105 inside the apparatus 100. The method 200 may be also applied to the aforementioned the control circuit 110. The control circuit 110 may obtain the predetermined configuration in advance, so that step 210 may be performed later. This is merely for illustrative purposes, however, and not a limitation of the present invention. The method 200 is detailed as follows.

In step 210, the control circuit 110 predicts at least one time interval (e.g. one or multiple time intervals) conforming to a predetermined condition according to the statistics data 122, to determine the target time and perform a timing operation corresponding to the target time, wherein the predetermined condition relates to the event count of the aforementioned time interval, and the target time is within the range of the time interval. The judgment module 112 may predict the time interval according to the statistics data 122 to determine the target time.

In step 220, when the target time expires, the control circuit 110 performs the aforementioned set of configuration updating operation (e.g. one or multiple configuration updating operations) upon the camera (such as the one or multiple PTZ cameras, or other types of cameras) through the interface circuit 130, and more particularly, applies the predetermined configuration to the camera through the interface circuit 130, wherein during the set of configuration updating operations, the video recording upon the surveillance system may temporally pause. The judgment module 112 may utilize the timer module 114 to perform the timing operation to trigger the set of configuration updating operations when the target time expires.

More particularly, when the target time is up, the timer module 114 may immediately inform the judgment module 112 that the target time is up, and the judgment module 112 may immediately trigger the set of configuration updating operations. Please note that, when the target time is up and the timer module 114 immediately informs the judgment module 112 that the target time is up, the judgment module 112 may determine whether the current moment is suitable for performing the set of configuration updating operations in advance, and then determine whether to immediately trigger the set of configuration updating operations. For example, if the judgment module 112 determines that the moment is suitable for performing the set of configuration updating operations, the judgment module 112 will immediately trigger this operation; otherwise, the judgment module 112 may predict the best time point (e.g. the latest value of the target time) again for performing configuration updating based on the latest contents of the statistics data 122, to selectively trigger the set of configuration updating operations at the new predicted best time point.

According to some embodiments, the control circuit 110 may calculate a plurality of decision-making indexes {DMI(1), DMI(2), . . . , DMI(N)} corresponding to a plurality of future time intervals {Tf(1), Tf(2), . . . , Tf(N)}, respectively, wherein the plurality of decision-making indexes {DMI(1), DMI(2), . . . , DMI(N)} correspond to the predicted event counts {P(1), P(2), . . . , P(N)} of the plurality of future time intervals {Tf(1), Tf(2), . . . , Tf(N)}, respectively. For example, the plurality of future time intervals {Tf(1), Tf(2), . . . , Tf(N)} may represent each hour of the next day, respectively, such as the time intervals 00:00-01:00, 01:00-02:00, . . . , 23:00-24:00. In another example, the plurality of future time intervals {Tf(1), Tf(2), . . . , Tf(N)} may represent a plurality of half-hours in the next day, respectively, such as 00:00-00:30, 00:30-01:00, . . . , 23:30-24:00.

The control circuit 110 may select at least one (e.g. one or multiple) candidate update time interval from the plurality of future time intervals {Tf(1), Tf(2), . . . , Tf(N)} based on the plurality of decision-making indexes {DMI(1), DMI(2), . . . , DMI(N)} and a decision-making index threshold value DMI_Th, wherein the candidate update time interval is within the whole range of the time interval, and the control circuit 110 may determine the target time based on the candidate update time interval. More particularly, the control circuit 110 may respectively obtain the predicted event counts {P(1), P(2), . . . , P(N)} based on at least one set of event counts corresponding to at least one set of previous time intervals {Tp}, and normalize the predicted event counts {P(1), P(2), . . . , P(N)}, to generate the plurality of decision-making indexes {DMI(1), DMI(2), . . . , DMI(N)} corresponding to the plurality of future time intervals {Tf(1), Tf(2), . . . , Tf(N)}, respectively, wherein the set of previous time intervals {Tp} correspond to the plurality of future time intervals {Tf(1), Tf(2), . . . , Tf(N)}, respectively. For example, the set of previous time intervals {Tp} may be one set of the previous time intervals {Tp(1), Tp(2), . . . , Tp(N)}, wherein the set of event counts {E} may be one set of event counts {E(1), E(2), . . . , E(N)} corresponding to the set of previous time intervals {Tp(1), Tp(2), . . . , Tp(N)}. In this situation, the set of previous time intervals {Tp} includes a single set of event counts, such as the set of event counts {E(1), E(2), . . . , E(N)}. In another example, the set of previous time intervals {Tp} may include a plurality of sets of previous time intervals, such as the following D sets of previous time intervals: {{Tp(1), Tp(2), . . . , Tp(N)}, {Tp(N+1), Tp(N+2), . . . , Tp(2N)}, {Tp(2N+1), Tp(2N+2), . . . , Tp(3N)}, . . . , {Tp((D−1)*N+1), Tp((D−1)*N+2), . . . , Tp(D*N)}}, wherein the set of event counts {E} may include a plurality of sets of event counts, such as the D sets of event counts {{E(1), E(2), . . . , E(N)}, {E(N+1), E(N+2), . . . , E(2N)}, {E(2N+1), E(2N+2), . . . , E(3N)}, . . . , {E((D−1)*N+1), E((D−1)*N+2), . . . , E(D*N)}} corresponding to the D sets of previous time intervals {{Tp(1), Tp(2), . . . , Tp(N)}, {Tp(N+1), Tp(N+2), . . . , Tp(2N)}, {Tp(2N+1), Tp(2N+2), . . . , Tp(3N)}, . . . , {Tp((D−1)*N+1), Tp((D−1)*N+2), . . . , Tp(D*N)}}, respectively.

According to some of these embodiments, under the situation where the set of previous time intervals {Tp} is merely one set of previous time intervals {Tp(1), Tp(2), . . . , Tp(N)}, the set of previous time intervals {Tp(1), Tp(2), . . . , Tp(N)} is within a time period such as a specific past day, and the control circuit 110 may generate the plurality of decision-making indexes {DMI(1), DMI(2), . . . , DMI(N)} corresponding to the plurality of future time intervals {Tf(1), Tf(2), . . . , Tf(N)} respectively based on the set of event counts {E(1), E(2), . . . , E(N)} corresponding to the set of previous time intervals {Tp(1), Tp(2), . . . , Tp(N)}, wherein the control circuit 110 may use the single set of event counts such as the set of event counts {E(1), E(2), . . . , E(N)} as the predicted event counts {P(1), P(2), . . . , P(N)}. For example, the plurality of future time intervals {Tf(1), Tf(2), . . . , Tf(N)} may respectively represent each hour in a next day, the set of previous time intervals {Tp(1), Tp(2), . . . , Tp(N)} may respectively represent each hour in a specific past day, and the set of event counts {E(1), E(2), . . . , E(N)} may respectively represent the event counts of the plurality of hours in a specific past day, wherein the control circuit 110 may obtain the set of event counts {E(1), E(2), . . . , E(N)} corresponding to the set of previous time intervals {Tp(1), Tp(2), . . . , Tp(N)} respectively from the statistics data 122.

Under the situation where the aforementioned at least one set of previous time intervals {Tp} include D sets of previous time intervals {{Tp(1), Tp(2), . . . , Tp(N)}, {Tp(N+1), Tp(N+2), . . . , Tp(2N)}, {Tp(2N+1), Tp(2N+2), . . . , Tp(3N)}, . . . , {Tp((D−1)*N+1), Tp((D−1)*N+2), . . . , Tp(D*N)}}, the D sets of previous time intervals {{Tp(1), Tp(2), . . . , Tp(N)}, {Tp(N+1), Tp(N+2), . . . , Tp(2N)}, {Tp(2N+1), Tp(2N+2), . . . , Tp(3N)}, . . . , {Tp((D−1)*N+1), Tp((D−1)*N+2), . . . , Tp(D*N)}} are within a plurality of time periods, respectively, such as a first time period, a second time period, a third time period, . . . , and a D-th time period within D time periods. Further, a d-th set of event count {E((d−1)*N+1), E((d−1)*N+2), . . . , E(d*N)} within the D sets of event counts corresponds to the d-th set of previous time interval {Tp((d−1)*N+1), Tp((d−1)*N+2), . . . , Tp (d*N)} within the D sets of previous time intervals, and the d-th set of previous time interval {Tp((d−1)*N+1), Tp((d−1)*N+2), . . . , Tp(d*N)} is within the d-th time period within the D time periods, wherein the notation “d” represents any integer falling within the interval [1, D]. The control circuit 110 may perform a plurality of weighted average operations based on the plurality of sets of event counts, so as to generate a set of average event counts {AVG(1), AVG(2), . . . , AVG(N)} corresponding to the plurality of future time intervals {Tf(1), Tf(2), . . . , Tf(N)}, and generate the plurality of decision-making indexes {DMI(1), DMI(2), . . . , DMI(N)} corresponding to the plurality of future time intervals {Tf(1), Tf(2), . . . , Tf(N)} based on the set of average event counts {AVG(1), AVG(2), . . . , AVG(N)}, respectively, wherein the control circuit 110 may use the set of average event counts {AVG(1), AVG(2), . . . , AVG(N)} as the predicted event counts {P(1), P(2), . . . , P(N)}.

For example, the plurality of time periods may be some previous days, and the control circuit 110 may obtain the d-th event count {E((d−1)*N+1), E((d−1)*N+2), . . . , E(d*N)} corresponding to the d-th previous time interval {Tp((d−1)*N+1), Tp((d−1)*N+2), . . . , Tp(d*N)} from the statistics data 122, such as the first set of event counts {E(1), E(2), . . . , E(N)} of the first set of previous time intervals {Tp(1), Tp(2), . . . , Tp(N)}, the second set of event counts {E(N+1), E(N+2), . . . , E(2N)} corresponding to the second set of previous time intervals {Tp(N+1), Tp(N+2), . . . , Tp(2N)}, . . . , and the D-th set of event counts {E((D−1)*N+1), E((D−1)*N+2), . . . , E(D*N)} corresponding to the D-th set of previous time intervals {Tp((D−1)*N+1), Tp((D−1)*N+2), . . . , Tp(D*N)}.

In an embodiment, the plurality of future time intervals {Tf(1), Tf(2), . . . , Tf(N)} may represent each hour of a next day as mentioned above, and the d-th previous time interval {Tp((d−1)*N+1), Tp((d−1)*N+2), . . . , Tp(d*N)} may represent each hour of the d-th day within the past few days, i.e., the hours of the d-th day within the past few days corresponding to the hours of the next day (such as the time intervals 00:00-01:00, 01:00-02:00, . . . , 23:00-24:00). For example, the first set of previous time intervals {Tp(1), Tp(2), . . . , Tp(N)} may respectively represent each hour of the first day within the past D days, the second set of previous time intervals {Tp(N+1), Tp(N+2), . . . , Tp(2N)} may respectively represent each hour of the second day within the past D days, and so on. Further, the D-th set of previous time intervals {Tp((D−1)*N+1), Tp((D−1)*N+2), . . . , Tp(D*N)} may respectively represent each hour of the D-th day within the past D days, e.g. each hour of the past day mentioned in this embodiment.

In this embodiment, the d-th event count {E((d−1)*N+1), E((d−1)*N+2), . . . , E(d*N)} may represent the event count of each hour of the d-th day within the past D days, wherein the control circuit 110 may generate the d-th event count {E((d−1)*N+1), E((d−1)*N+2), . . . , E(d*N)} by counting the number of events which happened in each hour of the d-th day within the past D days, respectively. For example, the first set of event counts {E(1), E(2), . . . , E(N)} may respectively represent the event count of each hour of the first day within the past D days, the second set of event counts {E(N+1), E(N+2), . . . , E(2N)} may respectively represent the event count of each hour of the second day within the past D days, and so on. Further, the D-th set of event counts {E((D−1)*N+1), E((D−1)*N+2), . . . , E(D*N)} may represent the event count of each hour of the D-th day within the past D days.

Hence, the control circuit 110 may perform a plurality of weighted average operations, such as N weighted average operations, based on the plurality of sets of event counts {{E(1), E(2), . . . , E(N)}, {E(N+1), E(N+2), . . . , E(2N)}, {E(2N+1), E(2N+2), . . . , E(3N)}, . . . , {E((D−1)*N+1), E((D−1)*N+2), . . . , E(D*N)}}, to generate the set of average event counts {AVG(1), AVG(2), . . . , AVG(N)}, wherein one weighted average operation within the plurality of weighted average operations may comprise performing weighted average operations upon the corresponding event counts E(n), E(N+n), E(2N+n), . . . , and E((D−1)*N+n) that correspond to each other within the plurality of sets of event counts {{E(1), E(2), . . . , E(N)}, {E(N+1), E(N+2), . . . , E(2N)}, {E(2N+1), E(2N+2), . . . , E(3N)}, . . . , {E((D−1)*N+1), E((D−1)*N+2), . . . , E(D*N)}}, wherein the symbol “n” may represent any positive integer within the interval [1, N]. More particularly, the set of average event counts {AVG(1), AVG(2), . . . , AVG(N)} in this embodiment may be represented by the following equations:

$$AVG ( 1 ) = {w}_{1} E ( 1 ) + {w}_{2} E ( N + 1 ) + {w}_{3} E ( 2 N + 1 ) + … + {w}_{D} E ( ( D - 1 ) * N + 1 ) ;$$

$$AVG ( 2 ) = {w}_{1} E ( 2 ) + {w}_{2} E ( N + 2 ) + {w}_{3} E ( 2 N + 2 ) + … + {w}_{D} E ( ( D - 1 ) * N + 2 ) ;$$

$$…$$

$$AVG ( N ) = {w}_{1} E ( N ) + {w}_{2} E ( 2 N ) + {w}_{3} E ( 3 N ) + … + {w}_{D} E ( D * N ) ;$$

wherein the symbols “w₁”, “w₂”, “w₃”, . . . , and “w_{D}” represent the weightings of the first day, second day, third day, . . . , and D-th day, respectively.

Under the situation where the first time period is earlier than the second time period, during the plurality of weighted average operations, the weighting of the first set of event counts is smaller than the weighting of the second set of event counts. More particularly, the condition “w₁<w₂<w₃< . . . <w_{D}” may be satisfied in the above equations. In other embodiments, these weightings can be modified such as being increased or decreased based on different days in a week listed in a calendar. For example, corresponding weightings within the weightings w₁, w₂, w₃ and w_{D} may be increased on some day(s) of a week, such as Monday, Tuesday and/or Wednesday. In another example, corresponding weightings within the weightings w₁, w₂, w₃, and w_{D} may be decreased on some day(s) of a week, such as Thursday, Friday and/or Saturday.

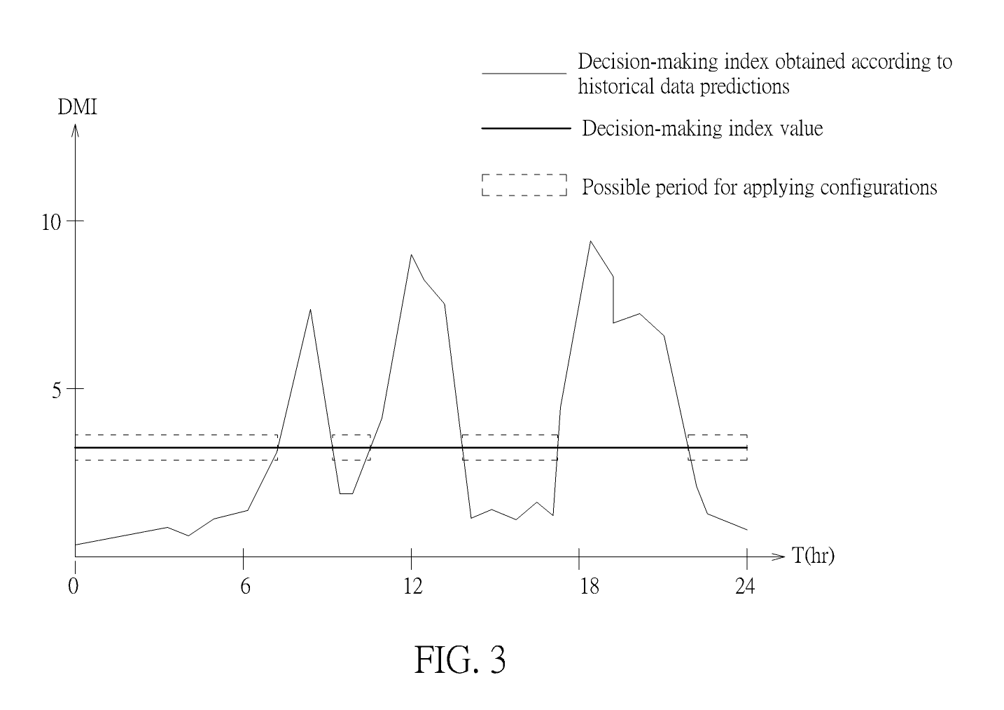

FIG. 3 is a diagram illustrating a control scheme of the method 200 shown in FIG. 2 according to an embodiment of the present invention, wherein the horizontal axis T represents time and uses hours (hr) as the unit, and the vertical axis DMI represents the decision-making indexes, such as the plurality of decision-making indexes {DMI(1), DMI(2), . . . , DMI(N)}. The curve formed of peaks and valleys shown in FIG. 3 shows the decision-making indexes obtained according to historical data predictions. The decision-making indexes may be viewed as an example of the plurality of decision-making indexes {DMI(1), DMI(2), . . . , DMI(N)}. As mentioned above, the control circuit 110 may normalize the predicted event counts {P(1), P(2), . . . , P(N)}. More particularly, the control circuit 110 may normalize the predicted event counts {P(1), P(2), . . . , P(N) to a range of a predetermined interval. According to this embodiment, the predetermined interval may be [0, 10]; however, this is merely for illustrative purposes, and not a limitation of the present invention. According to some modifications, the predetermined interval may be modified. No matter whether the predetermined interval is [0, 10] or some other range, after the normalizations, the user may easily set the value of the decision-making index threshold value DMI_Th, for selecting the candidate update time interval more easily. Further, the horizontal line across the curve represents a decision-making index threshold value, and this decision-making index threshold value may be viewed as an example of the decision-making index threshold value DMI_Th. The rectangles depicted by dotted lines represent the time possible for applying configurations, wherein the rectangles specify the time intervals where the curve is lower than the horizontal line.

According to this embodiment, the candidate update time interval includes a plurality of candidate update time intervals. For example, if the interval [0, 24] on the horizontal axis T represents a next day, the plurality of future time intervals {Tf(1), Tf(2), . . . , Tf(N)} may respectively represent each half hour of the next day as mentioned above. In addition, any future time interval in the plurality of future time intervals {Tf(1), Tf(2), . . . , Tf(N)} falling within these time intervals may be an example of the plurality of candidate update time intervals, wherein no matter whether D=1 or D>1, the d-th set of previous time intervals {Tp((d−1)*N+1), Tp((d−1)*N+2), . . . , Tp(d*N)} may represent each “half hour” of the d-th day within the past D days, i.e. each “half hour” (such as the time intervals 00:00-00:30, 00:30-01:00, . . . , and 23:30-24:00) in the d-th day within the past D days corresponding to the time of the aforementioned next day. More particularly, the control circuit 110 may compare each decision-making index DMI within the plurality of decision-making indexes {DMI(1), DMI(2), . . . , DMI(N)} with the decision-making index threshold value DMI_Th, so as to search for at least one (e.g. one or multiple) set of adjacent time intervals where the corresponding index does not exceed the decision-making index threshold value DMI_Th in the plurality of future time intervals {Tf(1), Tf(2), . . . , Tf(N)}, such as some of the time intervals indicated by the rectangles. Note that the set of adjacent time intervals may be viewed as at least one set of candidate update time intervals within the plurality of candidate update time intervals.

In this way, the control circuit 110 may select a specific set of adjacent time intervals from the set of adjacent time intervals (e.g. one or multiple sets of adjacent time interval), to determine the target time. Since the number of the time intervals of the aforementioned curve (i.e. the number of the rectangles) in this embodiment lower than the horizontal line is larger than 1, the set of adjacent time intervals includes a plurality of sets of adjacent time intervals. In order to find the best time point for updating, the control circuit 110 may select a time interval closest to the current time point from the time intervals indicated by the rectangles in order to determine the target time in this closest time interval. This is merely for illustrative purposes, and not a limitation of the present invention. According to some modifications, the control circuit 110 may select a largest time interval from the time intervals indicated by the rectangles to determine the target time in this largest time interval. According to an embodiment, in multiple time intervals closest to the current time point, the control circuit 110 may select a time interval which is larger than a predetermined shortest interval to determine the target time in this time interval, wherein the predetermined shortest time interval may be set by the user. According to another embodiment, the predetermined shortest time interval may be replaced with an average consumption time required for applying all the configurations (or settings) to the camera 150. According to yet another embodiment, the predetermined shortest time interval may be replaced with the longest consumption time required for applying all the configurations (or settings) to the camera 150.

In practice, the control circuit 110 may select the specific set of adjacent time intervals from the plurality of sets of adjacent time intervals based on this rule, wherein the length of the specific set of adjacent time intervals in the plurality of sets of adjacent time intervals is larger than the length of any other set of adjacent time intervals. In some embodiments, the leftmost time interval shown in FIG. 3 is the longest time interval within the time interval indicated by the rectangles. Hence, the leftmost time interval is exactly the distribution range of the specific set of adjacent time intervals in this embodiment.

The detailed implementations regarding generating and updating the statistics data 122 (e.g. the aforementioned historical data), are illustrated as follows. The aforementioned at least one camera sends back a captured image to a central control device of the surveillance system for recording videos, wherein the control circuit 110 is configured inside the central control device. For example, the control circuit 110 may directly obtain the image captured by the camera. In another example, the control circuit 110 may indirectly obtain the image captured by the camera from the video data.

According to this embodiment, the control circuit 110 may detect whether there is any event based on the image captured by each PTZ camera, and record at least one detection result (e.g. one or multiple detection results) into the storage unit 120. For example, the detection result may contain information regarding whether any event has occurred. In other words, the detection result may indicate that there is an event or there is no event. No matter what the detection result indicates, the control circuit 110 may collect a series of detection results, and generate or update the statistics data 122 based on changes in the series of detection results with time.

Note that, when there is no difference between a series of images captured by this PTZ camera in a same direction, the control circuit 110 may determine that no event occurs in this direction. Further, when there is a difference between a series of images captured by this PTZ camera in the same direction, the control circuit 110 may determine that there is an event in this direction. In this way, the control circuit 110 may record the relationship between the camera event and time, wherein the aforementioned camera event may include a video event, i.e. the event detected by the control circuit 110 based on video images. For example, when a previous image is empty and suddenly a person appears in the latest image, the control circuit 110 may determine that an event has occurred, wherein the control circuit 110 may selectively send an alert based on some setting (such as user settings). Hence, the control circuit 110 may collect the detection result and record the corresponding time to generate or update the statistics data 122, and more particularly, to generate or update individual statistics data corresponding to this PTZ camera in the statistics data 122. This is merely for illustrative purposes, and not a limitation of the present invention. The aforementioned camera event may include (but is not limited to): recording a number of detected persons, and detecting actions (e.g. detecting the movement of a specific object or a specific person in the image), the disappearance of a specific object in the image, an object in a specific area from outside, the visual block of a specific area in the image, the image out of focus, or recording triggered by an electronic signal. For example, under the control of the circuit 110, the user interface of the surveillance system may allow the user to examine an event from a plurality of candidate events (or candidate event types) to be used as the aforementioned camera event, making the surveillance system suitable for various usages, wherein the user may avoid incorporating some unimportant events into the aforementioned camera events.

As mentioned above, when there is a difference between a latest image and a previous image in a series of images captured by the PTZ camera in the same direction, the control circuit 110 may determine that an event occurs in this direction. According to some embodiments, in order to avoid fake alarms (e.g. fake alarms caused by noise or bugs), the judgment mechanism for determining whether there is a difference between the latest image and the previous image may be modified. For example, when the difference between the latest image and the previous image of a series of images captured by this PTZ camera in the same direction is obvious (e.g. when the difference exceeds a threshold value), the control circuit 110 may determine that an event occurs. According to an embodiment, this PTZ camera may determine whether an event occurs, and send back the corresponding detection result to the control circuit 110. According to another embodiment, this PTZ camera may determine whether an event occurs to generate the corresponding detection result, generate the statistics data based on the detection result, and send back the statistics data to the control circuit 110, wherein the statistics data can be stored along with video images, and more particularly, the statistics data can be stored in metadata of the image.

According to some embodiments, no matter whether the storage unit 120 is configured inside or outside the control circuit 110, the storage unit 120 may be used to store the statistics data 122, wherein the control circuit 110 may record the time spent on the set of configuration updating operations.

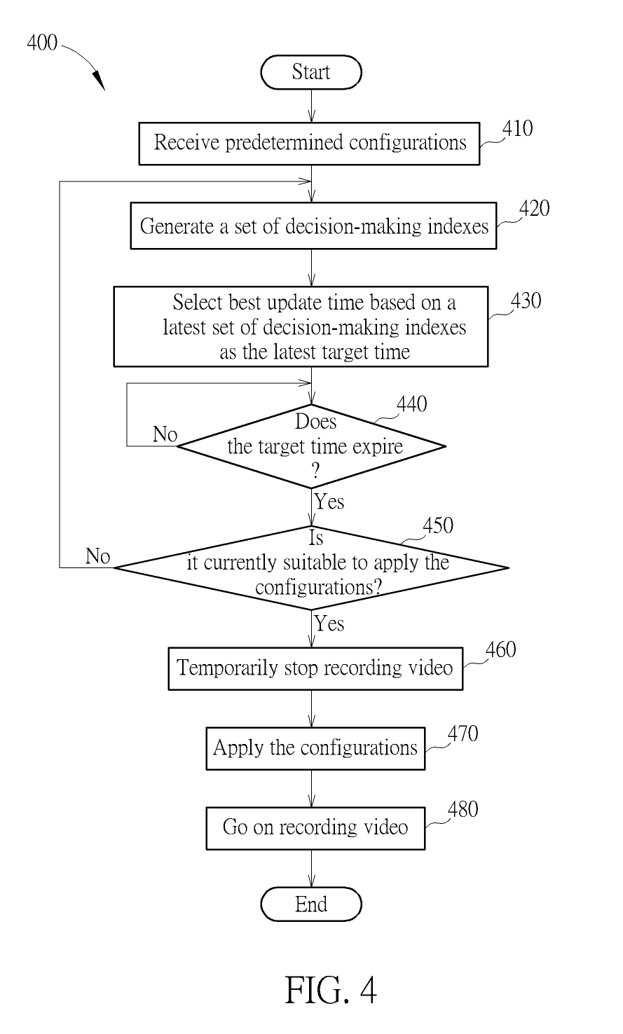

FIG. 4 is a diagram illustrating a work flow 400 involved by the method 200 shown in FIG. 2 according to an embodiment of the present invention. In step 410, the control circuit 110 receives some predetermined configurations, which may be an example of the predetermined configuration. For example, the predetermined configurations may be specified by the user of the surveillance system.

In step 420, the control circuit 110 generates a set of decision-making indexes {DMI}, such as the plurality of decision-making indexes {DMI(1), DMI(2), . . . , DMI(N)}.

In step 430, the control circuit 110 selects the best update time based on a latest set of decision-making indexes (e.g. the set of decision-making index {DMI} just generated by the control circuit 110 in step 420) as the latest target time. The latest target time in step 430 may be an example of the target time step 210.

In step 440, the control circuit 110 examines whether the target time (e.g. the latest update time just selected by the control circuit 110 in step 430) expires. When detecting that the target time expires, the flow goes to step 450; otherwise, the flow returns to step 440.

In step 450, the control circuit 110 examines if it is currently suitable to apply the configuration. The control circuit 110 may determine whether it is currently suitable to apply the configuration according to whether the new setting is urgent and whether the camera is in a peak period. When it is currently suitable to apply the configuration, the flow goes to step 460; otherwise, the flow returns to step 420.

In step 460, the control circuit 110 temporarily stops recording video.

In step 470, the control circuit 110 applies the configuration, and more particularly, applies the predetermined configurations received in step 410 to the camera 150.

In step 480, the control circuit 110 records video again.

Some detailed implementations in step 450 are illustrated as follows. The judgment module 112 may determine when to apply the configurations (or settings) of the PTZ camera. When receiving the notification of the change of the configurations (or settings) of the PTZ camera, the judgment module 112 may confirm whether the changed configurations (or settings) are preset as urgent by the user and therefore need to be applied immediately. If so, the judgment module 112 may control the apparatus 100 to immediately apply the changed configurations; otherwise, the judgment module 112 may determine whether it is currently suitable to immediately apply the configurations (or settings) according to the PTZ camera statistics data in a previous interval (e.g. according to the times of persons going in and out in the past hour or over the past few days), as well as according to the average time required by the PTZ camera to apply the configuration. If it is determined that it is currently suitable to immediately apply the configurations (or settings), the judgment module 112 may control the apparatus 100; otherwise, the judgment module 112 may register to the timer module 114 for a reselecting time to determine when to apply the configurations (or settings) again. According to an embodiment, the judgment module 112 may determine the peak period according to previous statistics data or a derivation date thereof, such as the curve shown in FIG. 3, to determine whether it is currently suitable to immediately apply the configurations (or settings). For example, the judgment module 112 may examine whether the decision-making index DMI corresponding to the current time point exceeds the decision-making index threshold value DMI_Th, to determine the peak period. If the decision-making index DMI corresponding to the current time point exceeds the decision-making index threshold value DMI_Th, the judgment module 112 may determine that the current time point is the peak period, and therefore it is not currently suitable to immediately apply the configurations (or settings). Otherwise, the judgment module 112 may determine that it is currently suitable to immediately apply the configurations (or settings).

According to an embodiment, under the situation where the judgment module 112 determines it is currently the peak period, the judgment module 112 may utilize a closest next time interval as a next time point. When the next time point is up, the judgment module 112 may perform calculations again to update the curve shown in FIG. 3 (or update the data represented by the curve shown in FIG. 3). If the judgment module 112 determines that it is still the peak period, a closest next time interval may be further utilized as a next time point.

According to some embodiments, the user may set weightings (e.g. weighting 1-weighting 10) for one specific setting of a PTZ camera (or all the PTZ cameras), to represent the urgency of applying the changes, wherein a larger weighting represents a larger urgency. The weighting mentioned above may be an example of the aforementioned decision-making index threshold value DMI_Th. Further, when the intelligent and adaptive camera configuration updater 105 receives the request for changing the configurations (or settings), the judgment module 112 may predict the frequency that the aforementioned camera event occurs within a next period (the next 24 hours) based on the statistics data 122, such as the decision-making index {DMI} represented by the curve shown in FIG. 3. For example, if D=30, the aforementioned first time period, second time period, . . . , and D-th time period may represent the first day, second day, . . . , and the 30th day of the past 30 days, respectively, wherein the ratio among the weightings w₁, w₂, w₃, . . . , and w_{D} may be represented as follows: w₁:w₂:w₃: . . . :w_{D}=1:2:3: . . . :30. Please note this is merely for illustrative purposes, and is not a limitation of the present invention.

According to some embodiments, the timer module 114 may receive various inputs such as the target time from the judgment module 112. In this way, the judgment module 112 may inform the timer module 114 when the setting for determining the camera should be applied again.

When the time set by the judgment module 112 expires, the timer module 114 will inform the judgment module 112 of this situation. The configuration applying module 116 may be used to apply the configurations (or settings) of the camera 150. When the judgment module 112 triggers the aforementioned set of configuration updating operations, the configuration applying module 116 may temporarily stop using the camera 150, and then apply the configurations (or settings) to the camera 150. The configuration applying module 116 may then use the camera 150 again, and record the time consumed by the entire flow of the set of configuration updating operations, so the judgment module 112 can perform a determining operation. For example, the time consumed by the entire flow may be incorporated into the statistics data 122.

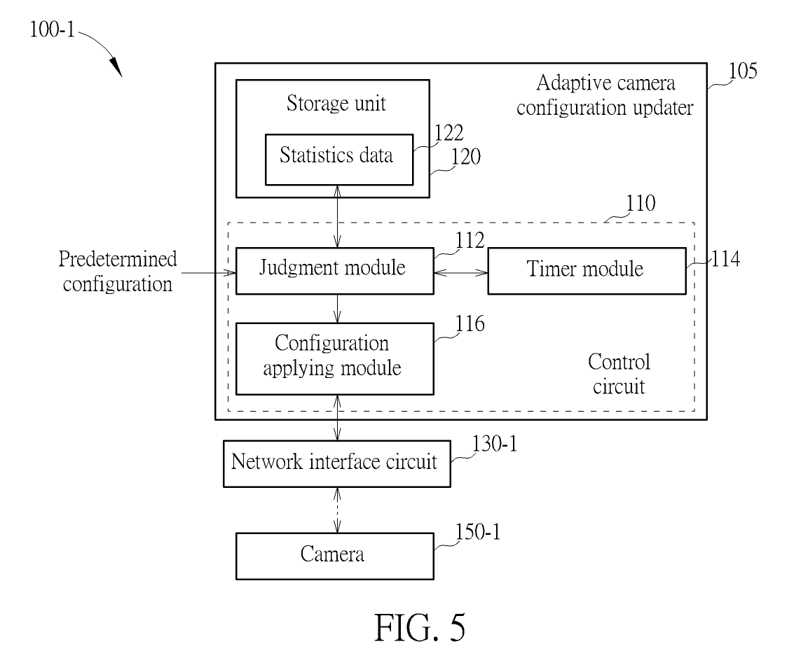

FIG. 5 is a diagram illustrating an apparatus 100-1 arranged for managing a surveillance system according to another embodiment of the present invention, wherein the method 200 shown in FIG. 2 (and the embodiments/modifications following the embodiment shown in FIG. 2) may also be applied to the apparatus 100-1 shown in FIG. 5. In this embodiment, the intelligent and adaptive camera configuration updater 105 in the apparatus 100-1 may also be applied to the control circuit 110. Compared with the embodiment shown in FIG. 1, the interface circuit 130 in the apparatus 100-1 is replaced with another interface circuit such as the network interface circuit 130-1, and the camera 150 is replaced with the camera 150-1. According to this embodiment, the camera 150-1 can communicate through a network. For example, the camera, particularly each PTZ camera of the aforementioned one or multiple PTZ cameras, can be an internet protocol (IP) camera. In practice, once the camera 150-1 is connected to the internet, the camera 150-1 may deliver information to the central control device through the internet. The detailed descriptions of this embodiment are identical to those of the previous embodiments/modifications and will therefore not be further described.

An advantage of the present invention is that, compared with the related art, the method and the apparatus of the present invention are capable of minimizing the possibility of losing important video data. The method and the apparatus of the present invention may apply a plurality of different configurations (or settings) to the camera 150 by updating these configurations (or settings). Further, the user may control the timing of updating the configurations (or settings) for the camera 150 through flexible settings.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for managing a surveillance system, the surveillance system comprising at least one camera, the method applied to a control circuit of the surveillance system and comprising:
predicting at least one time interval that complies with a predetermined condition based on statistics data to determine target time and performing a timing operation corresponding to the target time, wherein the predetermined condition relates to an event count of the at least one time interval, and the target time falls within a range of the time interval; and
performing at least one configuration updating operation upon the camera when the target time expires.

2. The method of claim 1, wherein the step of predicting the time interval that complies with the predetermined condition based on the statistics data to determine the target time and performing the timing operation corresponding to the target time further comprises:
calculating a plurality of decision-making indexes corresponding to a plurality of future time intervals, respectively, wherein each of the plurality of decision-making indexes corresponds to a predicted event count of one of the plurality of future time intervals;
selecting at least one candidate update time interval from the plurality of future time intervals according to the plurality of decision-making indexes and a decision-making index threshold value, wherein the candidate update time interval falls within the range of the time interval; and
determining the target time according to the candidate update time interval.

3. The method of claim 2, wherein the step of predicting the time interval that complies with the predetermined condition based on the statistics data to determine the target time and performing the timing operation corresponding to the target time further comprises:
obtaining the predicted event counts based on at least one set of event counts corresponding to at least one set of previous time intervals, respectively, wherein each set of the set of previous time intervals corresponds to the plurality of future time intervals, respectively; and
normalizing the predicted event counts, to generate the plurality of decision-making indexes corresponding to the plurality of future time intervals.

4. The method of claim 3, wherein the set of previous time intervals comprises a plurality of sets of previous time intervals, a first set of previous time intervals of the plurality of sets of previous time intervals falls within a first time period within a plurality of time periods, and a second set of previous time intervals within the plurality of sets of previous time intervals falls within a second time period within the plurality of time periods; the set of event counts comprises a plurality of sets of event counts, wherein the plurality of sets of event counts comprises a first set of event counts corresponding to the first set of previous time intervals, and a second event count corresponding to the second set of previous time intervals; and the step of predicting the time interval that complies with the predetermined condition based on the statistics data to determine the target time and performing the timing operation corresponding to the target time further comprises:
performing a plurality of weighted average operations based on the plurality of sets of event counts, to generate a set of average event counts corresponding to the plurality of future time intervals, respectively, wherein a weighted average operation within the plurality of weighted average operations comprises performing a weighted average operation upon corresponding event counts that correspond to each other in the plurality of sets of event counts; and
utilizing the set of average event counts as the predicted event counts.

5. The method of claim 4, wherein the first time period leads the second time period; and during performing the plurality of weighted average operations, a weight of the first set of event counts is smaller than a weight of the second set of event counts.

6. The method of claim 3, wherein the set of event counts comprises a single set of event counts; and the step of predicting the time interval that complies with the predetermined condition based on the statistics data to determine the target time and performing the timing operation corresponding to the target time further comprises:
utilizing the single set of event counts as the predicted event counts.

7. The method of claim 2, wherein the candidate update time interval comprises a plurality of candidate update time intervals; and the step of predicting the time interval that complies with the predetermined condition based on the statistics data to determine the target time and performing the timing operation corresponding to the target time further comprises:
comparing each of the plurality of decision-making indexes with the decision-making index threshold value, to find, from the plurality of future time intervals, at least one set of adjacent time intervals, each of which is associated to a corresponding decision-making index that does not exceed the decision-making index threshold value, wherein the set of adjacent time intervals is used as at least one set of candidate update time intervals within the plurality of candidate update time intervals; and
selecting a specific set of adjacent time intervals from the set of adjacent time intervals, to determine the target time.

8. The method of claim 7, wherein the set of adjacent time intervals comprises a plurality of sets of adjacent time intervals; and a length of the specific set of adjacent time intervals within the plurality of sets of adjacent time intervals is greater than or equal to a length of any other set of adjacent time intervals within the plurality of sets of adjacent time intervals.

9. The method of claim 1, wherein the step of performing the configuration updating operation upon the camera further comprises:
applying at least one predetermined configuration to the camera when the target time expires.

10. The method of claim 9, wherein the step of predicting the time interval that complies with the predetermined condition based on the statistics data to determine the target time and performing the timing operation corresponding to the target time further comprises:
after obtaining the predetermined configuration, predicting the time interval that complies with the predetermined condition based on the statistics data to determine the target time, and performing the timing operation corresponding to the target time.

11. An apparatus for managing a surveillance system, the surveillance system comprising at least one camera, the apparatus comprising at least a portion of the surveillance system, the apparatus comprising:
an interface circuit, arranged to couple to the camera; and
a control circuit, coupled to the interface circuit, the control circuit arranged to predict at least one time interval that complies with a predetermined condition based on statistics data, to determine target time, and perform a timing operation corresponding to the target time, wherein the predetermined condition relates to an event count of the time interval, the target time is within the time interval, and the control circuit performs at least one set of configuration updating operations upon the camera when the target time expires.

12. The apparatus of claim 11, wherein the control circuit calculates a plurality of decision-making indexes corresponding to a plurality of future time intervals, respectively, wherein each of the plurality of decision-making indexes corresponds to a predicted event count of each of the plurality of future time intervals; the control circuit selects at least one candidate update time interval from the plurality of future time intervals according to the plurality of decision-making indexes and a decision-making index threshold value, wherein the candidate update time interval is within the range of the time interval; and the control circuit determines the target time based on the candidate update time interval.

13. The apparatus of claim 12, wherein the control circuit obtains the predicted event counts based on at least one set of event counts corresponding to at least one set of previous time intervals, respectively, and normalizes the predicted event counts, to generate the plurality of decision-making indexes corresponding to the plurality of future time intervals, and normalizes the predicted event counts, to generate the plurality of decision-making indexes corresponding to the plurality of future time intervals, wherein each set of the at least one set of previous time intervals correspond to the plurality of future time intervals, respectively.

14. The apparatus of claim 13, wherein the set of previous time intervals comprises a plurality of sets of previous time intervals, a first set of previous time intervals of the plurality of sets of previous time intervals is within a first time period within a plurality of time periods, and a second set of previous time intervals within the plurality of sets of previous time intervals is within a second time period within the plurality of time periods; the set of event counts comprises a plurality of sets of event counts, wherein the plurality of sets of event counts comprise a first set of event counts corresponding to the first set of previous time intervals, and a second set of event counts corresponding to the second set of previous time intervals; and the control circuit performs a plurality of weighted average operations based on the plurality of sets of event counts, to generate a set of average event counts corresponding to the plurality of future time intervals, respectively, and utilizes the set of average event counts as the predicted event counts, wherein a weighted average operation within the plurality of weighted average operations comprises performing a weighted average operation upon a corresponding event count in each of the plurality of sets of event counts, respectively.

15. The apparatus of claim 14, wherein the first time period leads the second time period; and during performing the plurality of weighted average operations, a weight of the first set of event counts is smaller than a weight of the second set of event counts.

16. The apparatus of claim 13, wherein the set of event counts comprises a single set of event counts s; and the control circuit utilizes the single set of event counts and the predicted event counts.

17. The apparatus of claim 12, wherein the candidate update time interval comprises a plurality of candidate update time intervals; the control circuit compares each of the plurality of decision-making indexes with the decision-making index threshold value, to find, from the plurality of future time intervals, at least one set of adjacent time intervals, each of which is associated to a corresponding decision-making index that does not exceed the decision-making index threshold value, wherein the set of adjacent time intervals are used as at least one set of candidate update time intervals within the plurality of candidate update time intervals; and the control circuit selects a specific set of adjacent time intervals from the set of adjacent time intervals to determine the target time.

18. The apparatus of claim 17, wherein the set of adjacent time intervals comprises a plurality of sets of adjacent time intervals; and a length of the specific set of adjacent time intervals within the plurality of sets of adjacent time intervals is larger than or equal to a length of any other set of adjacent time intervals within the plurality of sets of adjacent time intervals.

19. The apparatus of claim 11, wherein when the target time expires, the control circuit applies at least one predetermined configuration on the camera through the interface circuit.

20. The apparatus of claim 19, wherein the control circuit predicts the time interval that complies with the predetermined condition based on the statistics data to determine the target time, and performs the timing operation corresponding to the target time after obtaining the predetermined configuration.

21. The apparatus of claim 11, further comprising:
a storage unit, configured inside or outside the control circuit, the storage unit arranged to store the statistics data;
wherein the control circuit records time consumed on recording the set of configuration updating operations.

22. The apparatus of claim 11, wherein the control circuit comprises:
a timer module, arranged to perform the timing operation; and
a judgment module, arranged to predict the time interval based on the statistics data to determine the target time, and utilize the timer module to perform the timing operation, to trigger the set of configuration updating operations when the target time expires.
